(19) United States
(12) Patent Application Publication
(10) Pub. No.: US 2009/0101783 A1
(43) Pub. Date: Apr. 23, 2009

(54) BEVERAGE COASTER

(76) Inventor: Eugune Howard Luoma, Duluth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/113,337

(22) Filed: May 1, 2008

Related U.S. Application Data
(60) Provisional application No. 60/982,006, filed on Oct. 23, 2007.

(51) Int. Cl. A47G 29/00; G09F 3/00; B21D 39/00

(52) U.S. Cl. 248/346.11; 40/324; 29/428

(57) ABSTRACT

A beverage coaster has a base and a tab disposed to the base. In a descended position, the tab occupies an aperture in the base. In an upright position, the tab is angularly positioned in relation to base of the beverage coaster so as to display an indicia. The indicia can communicate information relating to the condition of the patron, a request of the patron, or a condition of the beverage thereon.

### RELATED APPLICATIONS

The present application claims the benefit of U.S. Provisional Application No. 60/982,006, entitled BEVERAGE COASTER, filed Oct. 23, 2007, hereby fully incorporated herein by reference.

### FIELD OF THE INVENTION

The present application relates generally to beverage coasters, and more specifically, to beverage coasters that can selectively communicate a patron's imminent return.

### BACKGROUND OF THE INVENTION

Beverage coasters can be used to perform a variety of functions. For example, a beverage coaster can prevent damage to an underlying surface by a beverage container, such as a glass or a beer bottle. Such damage can be caused by condensation forming on a chilled beverage container, sliding the beverage container across the underlying surface, or the force of the impact when the beverage container is abruptly placed on the underlying surface. When positioned underneath beverage containers, beverage coasters can provide a moisture barrier, a moisture absorber, a nonabrasive intermediate surface, and protective cushion between the container and the underlying surface. Beverage coasters can also be used to provide a frictional surface to deter undesired sliding of the beverage or a stable temporary support surface for an otherwise uneven underlying surface.

Importantly, this causes contact of the water on napkins with the top exposed surface of the beverage container potentially transferring germs from the table top/counter to the surface that is by the mouth of the patron. This problem is exacerbated where the coaster is reused many times.

Beverage coasters are commonly used in bars, restaurants, and other serving establishments where beverages are served to patrons. Occasionally, a patron may wish to temporarily leave an area without carrying the beverage container. For example, statutory smoking restrictions have been enacted in many states that prohibit smoking in or around areas where beverages are served or consumed. As a result, patrons who wish to smoke are often required to exit the establishment or remove themselves to designated smoking areas, where it may be undesirable or unlawful to bring the beverage container. A patron may also wish to use restroom facilities at the establishment, where consumption of beverages from a beverage container would not be recommended amidst such unbygienic conditions. A number of other occasions exist at serving establishments which would not be conducive to the patron carrying a beverage container, such as, for example, dancing, entering a buffet line, or making a telephone call.

In many instances, the patron may leave behind a beverage container before having fully consumed the beverage. Thereafter, the beverage container is left unattended and the area formerly occupied by the patron is vacated. As a result even though the original patron may not have intended to abandon the beverage container or a particular location within the serving establishment, the beverage container may be prematurely cleared away or the patron's seating or standing area may become occupied by another patron. A problem exists in the patron effectively communicating in serving establishments to servers and other patrons of an intent to imminently return to a location to consume a beverage from a particular beverage container when left on a counter or table.

It is known to place a coaster or napkin on the top of a beverage container to signal the intent of the patron to return to the drink. This, of course, leaves the beverage container and table surface without the desired protection of the coaster or napkin.

In a preferred embodiment, a coaster has a thickness and comprises base portion and a flag portion as an indicator, the base portion and flag portion having the same thickness and the flag portion having a normal position and signaling position and repeatable convertible there between.

Therefore, there is a need for improved non-verbal communication or signaling of a patron's intent to the establishment. For example, the intent of the patron to imminently return to a particular beverage container or location in the serving establishment. In particular, there is a need to continuously communicate to serving establishment staff of the imminent return of a patron in a non-oral manner so as to deter premature disposal of the beverage container and discourage other patrons from occupying a particular seating or standing location within the establishment.

### SUMMARY OF THE INVENTION

The concerns described above are addressed by the present invention. A beverage coaster in a preferred embodiment has a base, a flag portion or tab, an indicia, and a joint section. The base comprises the flag portion or tab and a surrounding portion with a cut portion there between. The tab is hinged at the joint section and movable between a signaling position and a non signaling position. Indicia is disposed on the tab and is presented when the tab is in the signaling position. The indicia may be a linguistic phrase, a recognizable position, or a symbol. The indicia preferably indicates the condition or status of the patron or the beverage placed on the coaster. An aperture may be defined when the flag indicator is in the receiving position. The beverage coaster can receive a beverage container with the tab positioned within the aperture or substantially upright in relation to the base. The tab may conformingly fit within the aperture or be smaller than the aperture. The joint portion can be a perforation, a seam, a hinge, and some other device or configuration that facilitates alternate positioning of the tab.

In an embodiment, the invention may also include structure for retaining the flag portion in an upright position.

In an embodiment, the invention may have means, such as a bias, for returning the tab to the non-signaling position.

In embodiments, the invention may also include structure for facilitating multiple uses of flag portion indicator and aperture.

In embodiments, the flag portion may have positions, including two signaling positions.

In certain embodiments, the flag indicator, with two distinct sides, has different indicia on the two different sides. For example, the alternate indicia may signal: returning or not returning; or outside smoking; or restroom.

In preferred embodiments, an aperture extending through the coaster can be added to the coaster at the top of the flag portion for easy gripping of the flag portion and for readily displaying its existence.

A method of communicating an imminent return of a patron includes providing a beverage coaster having a tab and a base, positioning the tab to an upright position so that the base can receive a beverage container. In the upright position, the signal position, the tab can communicate the imminent return of a patron. Generally, the signal position is maintained by a beverage container seated on the coaster with flag portion propped against the beverage container.

A method of providing a coaster with a flag indicator includes forming a beverage coaster having a tab and a base and disposing the indicia onto the flag indicator. The indicia can be disposed on the flag indicator, for example, by printing a linguistic phrase, or a symbol indicator or on a substrate where the flag indicator will be, for example prior to cutting the flag indicator. Forming the beverage coaster can be accomplished, for example, by die-cutting the base from a sheet of high-density pulp board. Preferably a hinge is provided by the die cutting either by crushing, punching, perforating or cutting the region of the hinge and/or by utilizing a flexible polymer material at the hinge.

A feature and advantage of the invention is that the flag by being moved from a non-flagging position to a flagging position can indicate a request of a patron(such as: “do not remove beverage”, “refill”, “remove”, “provide another brand specific beverage”); a condition of a patron (such as: “soon to return”, “went to restroom”, or “not returning”); or a condition of a beverage (such as: “needs refilling”).

A feature and advantage is that the signaling can be provided in a sanitary and sustained manner and continuing while the patron is not immediately present.

In certain embodiments more than one tab may be provided in the base for providing alternate signals.

### BRIEF DESCRIPTION OF THE DRAWINGS

The embodiments of the present invention may be more completely understood in consideration of the following detailed description of various embodiments of the invention in connection with the accompanying drawings, in which:

FIG. 1 is a perspective view of a beverage coaster according to an embodiment of the present invention with the flag portion in the non signal position;

FIG. 2 is a perspective view of the opposite side of the beverage coaster of FIG. 1 according to an embodiment of the present invention;

FIG. 3 is perspective view of the beverage coaster according to an embodiment of the present invention with the flag portion in a signal position revealing a message by way of a first indicia;

FIG. 4 is perspective view of the beverage coaster of FIG. 3 turned over and with the flag portion in a signal position revealing a second indicia having a message different that the first indicia, this embodiment not utilizing a finger tab;

FIG. 5A is a perspective view of a beverage coaster with a beverage container thereon according to an embodiment of the present invention with a tab in a descended position providing no message;

FIG. 5B is a perspective view of a beverage coaster with a beverage container thereon according to an embodiment of the present invention with a tab in an upright signal position providing a message of an imminent return;

FIG. 6 is a perspective view of a beverage coaster with a beverage container thereon and according to an embodiment of the present invention with a tab in an upright position providing a message of no imminent return;

FIG. 7 is a cross-sectional view of a homogeneous coaster according to the invention;

FIG. 8 is a cross-sectional view of a beverage coaster according to an embodiment of the present invention formed of laminations including a polymer layer;

FIG. 9 is an exploded view of laminations to form a beverage coaster according to an embodiment of the present invention;

FIG. 10 is an exploded view of laminations to form a beverage coaster according to an embodiment of the present invention;

FIG. 11 is an exploded view of a beverage coaster according to an embodiment of the invention engaged with a beverage container;

FIG. 12 is an alternate configuration of a beverage coaster according to the invention;

FIG. 13 is an alternate configuration of a beverage coaster according to the invention;

FIG. 14 is an alternate configuration of a beverage coaster according to the invention;

FIG. 15 is an alternate configuration of a beverage coaster according to the invention; and

FIG. 16 is an alternate configuration of a beverage coaster according to the invention.

While the present invention is amendable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION

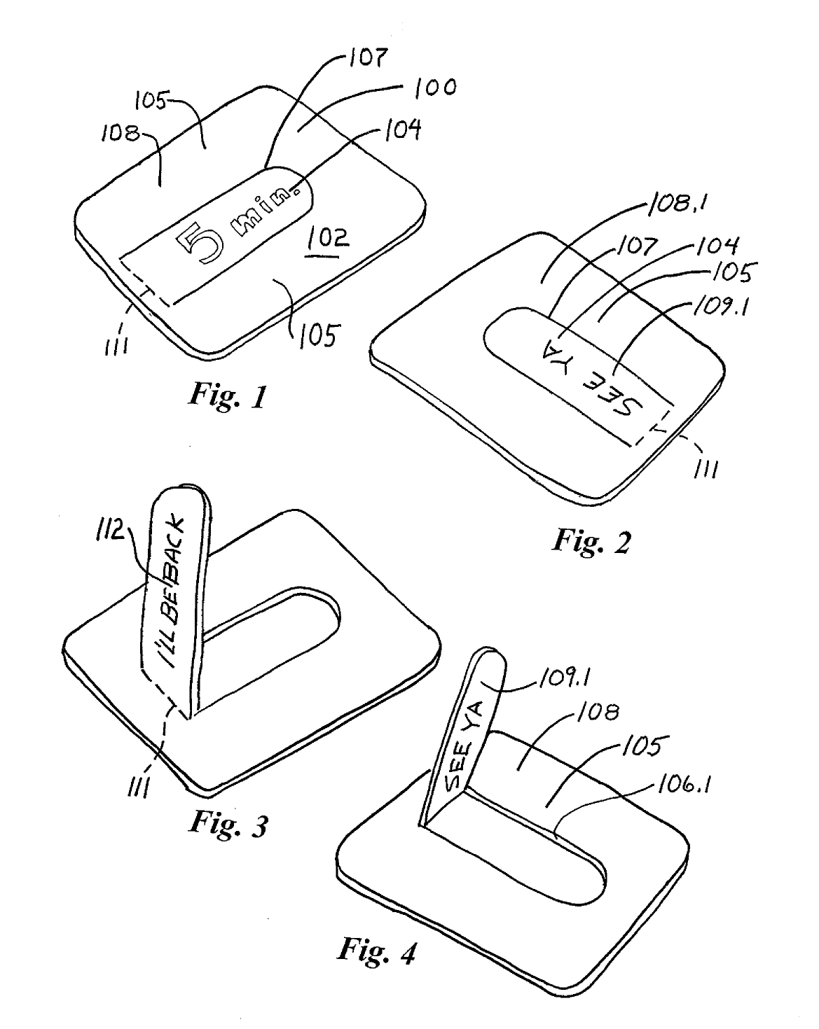

Referring to FIGS. 1-6, a beverage coaster 100 is depicted and generally comprises a base 102 with a flag indicator configured as a tab 104 and a surrounding portion 105. Flag portion, configured as a tab 104 and base 102 are connected at joint portion 111. The tab is defined by the cut portion 107 configured as a cut line. Referring specifically to FIGS. 3 and 4, the surrounding portion 105 defines aperture 106 and edge 106.1. The base has an upper surface 108 and lower surface 108.1. Tab 104 also has upper surface 109, lower surface 109.1, and edge 110. Tab 104 is connected to surrounding portion 105 at joint portion 111 and the tab and surrounding portion are preferably formed from a generally rigid substrate. “Rigid” meaning stiff enough to maintain its form in use. In an example embodiment, tab 104 is configured to conformingly fit within aperture 106. In another embodiment, tab 104 may be slightly smaller than aperture 106. The tab has a descended, flat, non signal position as shown in FIGS. 1 and 2, and an upright first signal position as shown in FIG. 3 or a second signal position as shown in FIG. 4, where the coaster is flipped over.

In an example embodiment, tab 104 presents first indicia 112 that, when put in the raised, flag or signal position, provides a signal relating to a patron or the beverage; for example, the imminent return of a patron. First indicia 112 may be any number of non-verbal messages capable of being communicated by tab 104. For example, indicia 112 may be a written instructive phrase with a text message. Written instructive phrases may include, by way of example, statements such as “I'LL BE BACK,” “RESERVED,” “DO NOT REMOVE,” “GONE SMOKING,” or any number of other text messages. Indicia 112 may also include symbols, illustrations, or other pictorial depictions. Such pictorial depictions may include, by way of example, a smoldering cigarette, musical notes, a stop sign, a beverage container, various objects, or any number of other messages.

Although indicia 112 may be descriptive of the patron's temporary whereabouts or activity, indicia 112 can also include non-descriptive messages. For example, indicia 112 can be a color, an advertising logo, or other graphic design selection. Indicia 112 can also include advertisements.

A second indicia 114 may be placed on the side of the flag portion, opposite the first indicia. The second indicia thereon may indicate preferably something opposing to the message of the first indicia, such as “Have Left”, or “All Done”.

A third indicia 115 can be placed on the base off of the flag indicator, on the surrounding portion and can provide traditional advertising, logos, or the like.

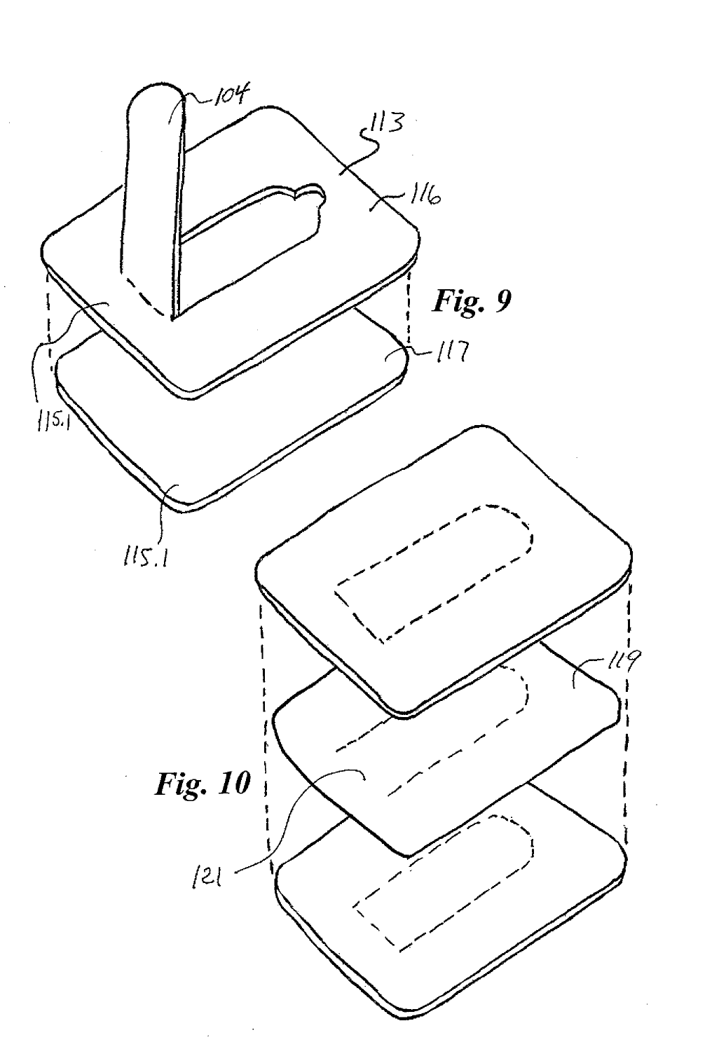

To facilitate presentation of first indicia 112, and second indicia 114, if present, base 102 and tab 104 can be formed in a number of ways and from a number of different materials. Referring to FIGS. 7, 8, 9 and 10, base 102 and tab 104 may advantageously be made from the same material. In an example embodiment, base 102 and tab 104 may be die-cut from high-density pulp board that is generally rigid and non flexible. Rigid being defined as having a form consistent as disclosed herein that is self supporting and will not bend more than 0.2 inches under the weight of gravity when secured at an edge and cantilevered horizontally. In alternative embodiments, base 102 and tab 104 can be made from cork, wood, plastic, a composite material, textile material, fibrous material, or some combination, such as laminating layers 115 of such materials with adhesive or otherwise affixing the layers together. The cut portion of the laminates may vary from layer to layer. FIG. 9 illustrates where a first layer 116 cut through forming the flag portion 104 but the second layer 117 is not cut. A finger slot 113 is cut into the first layer to facilitate grasping of the flag portion when in the inclined position to raise it to the flag position. FIG. 10 illustrates a lamination where the layers are cut as illustrated by the dashed lines. An upper layer 118 and lower layer 120 are cut entirely around to define the flag portion 104. The intermediate layer 119 is partially cut to the shape of the flag portion but not at the hinge portion 121. The intermediate layer may thus be selected to be more flexible than the upper or lower layers and may be selected to be resilient to urge the flag portion to return to the non signal flat position. The intermediate layer may be a polymer sheet material or a fabric or other flexible sheet material. Referring to FIGS. 15 and 17, alternatively, flexible portions of material, such as a strip, may be adhered to a surface of a layer that is cut entirely through defining a flag portion whereby the strip with adhesive material, such as tape 130, is applied to the exterior surface of the non-flag portion and the flag to provide a hinge 132. This can be provided on one or both sides of the coaster. Such strip may be formed of a sheet material, such as a polymer, or a fabric and may be provided on both sides providing some resilient stretchable characteristic. In such embodiments, the hinge can provide a bias to urge the flag 142 to the normal position parallel and coplanar to the non flag portion 144 when raised as illustrated in FIG. 16.

Alternatively to utilizing a flexible material for the hinge portion, such may be formed by perforating or putting a crease in the base material such that the hinge portion is flexible.

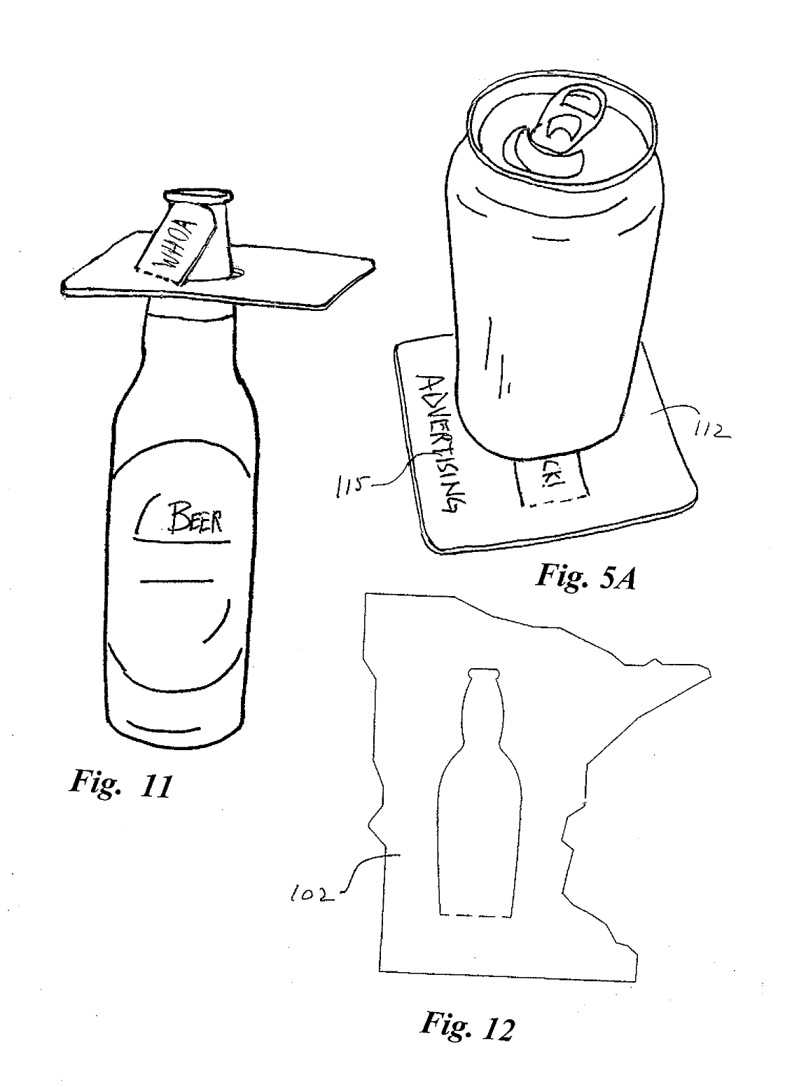

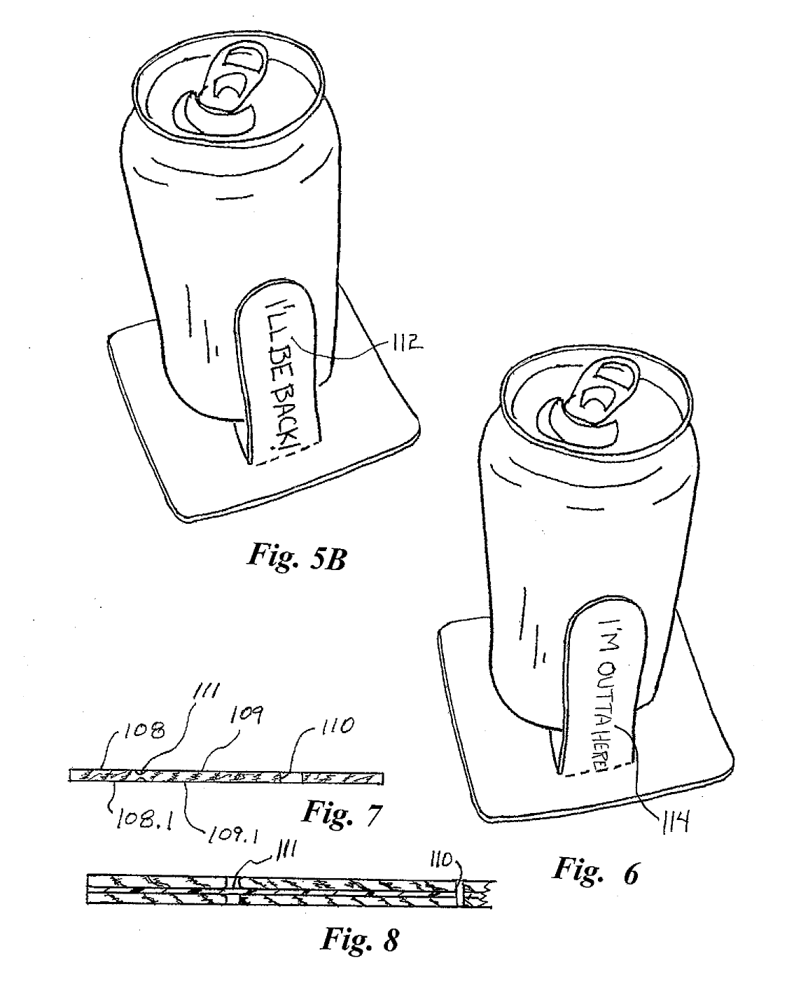

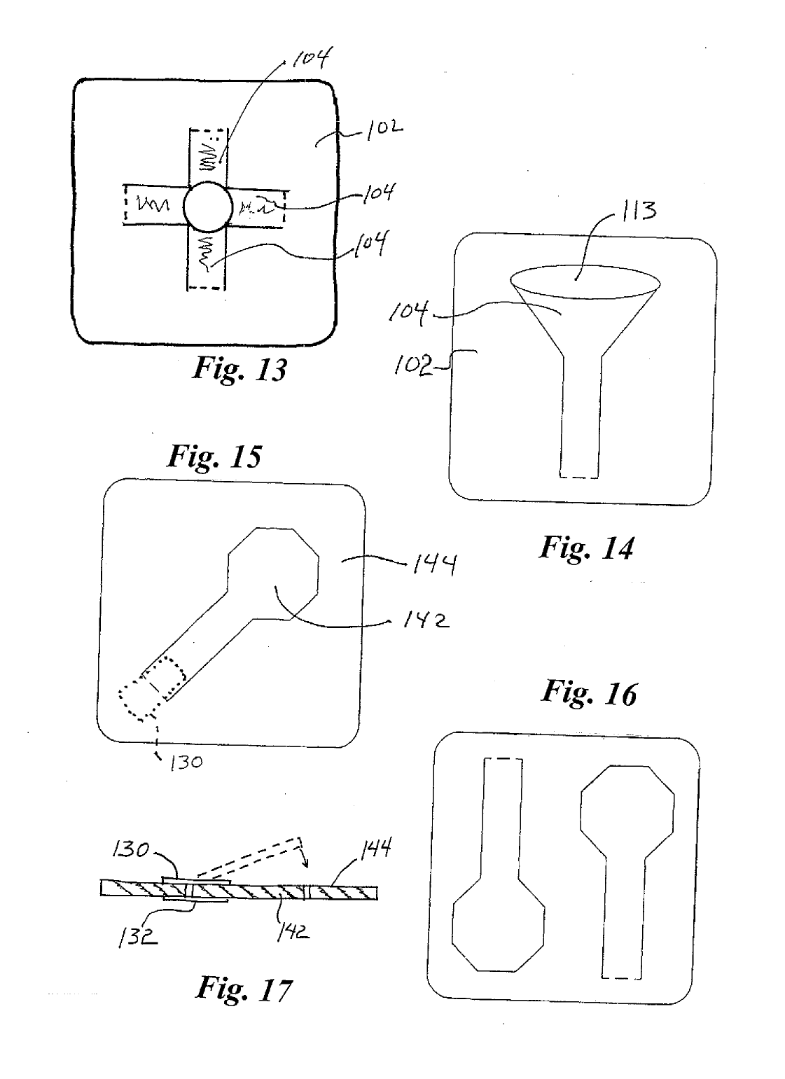

As illustrated in FIGS. 11-16, base 102 can be of various closed geometric figures. Similarly, flag portion 104 can be of various shapes without departing from the spirit and scope of the present invention. In an example embodiment, base 102 of beverage coaster 100 is large enough to accommodate beverage container 122, and is in an embodiment at least about 8 square inches in area. In a preferred embodiment, the area of the base, including the flag portion, is at least about 10 square inches. The area of the base is less than about 25 square inches and preferably less than about 18 square inches in area. Beverage container 122 can be any type of receptacle commonly used to hold a beverage. For example, beverage container 122 can be a t glass, a longneck bottle (as depicted in FIG. 11), a can (as depicted in FIGS. 5A, 5B, and 6).

In an example embodiment, aperture 106 is elongate in shape defining elongate flag portions. In other embodiments, tab 104 can be substantially circular or configured to convey an image associated with the serving establishment or an advertiser. The flag portion can be complex in shape and can be positioned other than centrally on the coaster. For example, the flag portion may be U-shaped or may be positioned on the periphery of coaster. More than one flag portion can be utilized to provide alternate or different messages including messages relating to the patron returning or not returning, the status of the drink, that is not finished, finished and please replace or refill, the location of the patron, or the timing of the return.

Beverage coaster 100 can be used like most traditional coasters, as depicted in FIGS. 5A with the flag portion 104 in a descended position, non flagging position, beverage coaster 100 defines a substantially planar surface on which beverage container 122 can be placed. When a patron of a serving establishment wishes to temporarily leave without bringing beverage container 122, beverage coaster 100 can be used to signal the patron's imminent return as illustrated in FIG. 5B. The patron or staff of the establishment may raise the flag portion providing the signal and messaging. The message of FIG. 6 provides a signal that definitely indicates when a patron is leaving and that the beverage container may be removed.

Referring to FIG. 11, the beverage coaster can be configured to allow placement over a bottle, such as a beer bottle, with the flag moved to the signal position to provide a message of imminent return, no return, please refill, or the like.

Referring to FIGS. 3, 4, 5, and 6, tab 104 can form an angle in relation to base 102 of approximately ninety degrees or less in the upright position.

Although various embodiments of the present invention have been disclosed herein for purposes of illustration, it should be understood that a variety of changes, alterations, and substitutions may be incorporated without departing from the spirit or scope of the present invention. The invention may be embodied in other specific forms without departing from the essential attributes thereof; therefore, the illustrated embodiments should be considered in all respects as illustrative and not restrictive.

1. A beverage coaster comprising:
a base formed of a rigid substrate, the base comprising a flag indicator and a surrounding portion, the flag indicator connected to the surrounding portion by a joint portion,
an indicia disposed on the flag indicator, the indicia indicative of at least one of a condition of a patron, a request of a patron, and a condition of a beverage of a patron, to be placed on the coaster, the flag indicator having a horizontal position coplanar with respect to the surrounding portion and an upright flagging position for displaying said indicia.

2. The beverage coaster of claim 1, wherein the indicia relates to an imminent return of a patron.

3. The beverage coaster of claim 1, wherein the indicia comprises a linguistic phrase.

4. The beverage coaster of claim 1, wherein the base is formed of a fibrous composite material and the joint portion is formed of one of a textile material or a polymer sheet material.

5. The beverage coaster of claim 1, wherein the tab conformingly fits within the aperture.

6. The beverage coaster of claim 1, wherein the tab fits within the aperture to form an access area from which an edge of the tab can be accessed.

7. The beverage coaster of claim 1, wherein the tab has a top surface and a bottom surface and wherein there is indicia on both the top surface and the bottom surface, the indicia providing different condition status of one of the patron and the beverage.

8. The beverage coaster of claim 9, wherein the base is sized to receive a bottom surface of the beverage container and has an area of at least about 10 square inches.

9. The beverage coaster of claim 1, wherein the base and the tab are die-cut high-density pulp board.

10. The beverage coaster of claim 1, wherein the base defines an upper surface and a lower surface, the lower surface having a second indicia to communicate the imminent return of a patron.

11. The beverage coaster of claim 1, wherein the aperture defines a length and a width and the beverage container is a standard longneck bottle having a circular base, the width being less than diameter of the circular base.

12. The beverage coaster of claim 1, wherein the joint portion urges the tab to the descended position.

13. The beverage coaster of claim 1, wherein the joint portion comprises a perforation.

14. The beverage coaster of claim 1, wherein the joint portion comprises a seam in the beverage coaster.

15. The beverage coaster of claim 1, wherein the joint portion is formed by folding the tab.

16. A method of communicating an imminent return of a patron comprising the steps of:
providing a beverage coaster comprising a base with a periphery, a flag portion spaced from the periphery, a surrounding portion that surrounds the flag portion and extends to the periphery, and having a joint portion connecting the flag portion to the surrounding portion, the flag portion having an indicia thereon indicative of the condition of a patron with regard to his intent to return to the beverage; positioning the tab to an upright position so that the base can receive a beverage container and support the flag portion in an upright manner

17. A method of manufacturing a beverage coaster, the method comprising the steps of:
cutting a rigid substrate to define the periphery of the coaster;
cutting a flag portion within a surrounding portion on the rigid substrate;
forming a joint portion to extend between the flag portion and the surrounding portion; and
disposing indicia on the flag portion, the indicia relating to one of a condition of a patron utilizing the coaster and a condition of a beverage thereon.

18. The method of claim 17, wherein the method of disposing the indicia further comprises printing a text message.

19. The method of claim 17, further comprising the step of forming a beverage coaster further comprises die-cutting the tab and the base from high-density pulp board.

20. The method of claim 17, further comprising the step of using a resilient material for the joint portion thereby providing a bias for the flag to return to a non flagging position.
